(19) United States
(12) Patent Application Publication
(10) Pub. No.: US 2011/0251734 A1
(43) Pub. Date: Oct. 13, 2011

(54) METHOD FOR THE ADAPTION OF A DRIVING BEHAVIOR OF A VEHICLE WITH A CHANGE OF DRIVER

(75) Inventors: Oliver SCHEPP, Idstein (DE); Ali KHANAFER, Mainz (DE); Ingobert LASSRICH, Trebur (DE); Oliver WAGNER, Gross-Gerau (DE); Ralf RATHMACHER, Schmitten im Taunus (DE); Thomas SCHRAMM, Ruesselsheim (DE)

(73) Assignee: GM GLOBAL TECHNOLOGY OPERATIONS LLC, Detroit, MI (US)

(21) Appl. No.: 13/082,158

(22) Filed: Apr. 7, 2011

(30) Foreign Application Priority Data
Apr. 7, 2010 (DE) 102010014076.7

(51) Int. Cl. G06F 7/00

(52) U.S. Cl. 701/1

(57) ABSTRACT

A method is provided for the adaption of a driving behavior of a vehicle with a change of driver. For this, driver-specific driving parameters, which characterize a driving style of a driver, of several vehicle drivers are stored as virtual driver profiles in the vehicle or in a drivers' control center. In addition, various methods are stored driver-specifically in the vehicle or in a drivers' control center, which respectively modify a reaction of the vehicle to driving parameters of a driver to the effect that a manner of driving, taking into account the limits of the vehicle, is ensured in traffic. During the driving of the vehicle, a first of the methods is then used and a comparison of stored virtual driver profiles with actually detected driver-specific driving parameters is carried out. If on comparing the actually detected driver-specific driving parameters a change of driver is clearly recognized and an allocation to one of the stored virtual driver profiles was not able to take place, a change-over is made to a next one of the methods until the driver is recognized or, if a recognition is not possible by means of the stored data, a further safety method is created for a new virtual driver.

### CROSS-REFERENCE TO RELATED APPLICATION

This application claims priority to German Patent Application No. 102010014076.7, filed Apr. 7, 2010, which is incorporated herein by reference in its entirety.

### TECHNICAL FIELD

The technical field relates to a method for the adaption of a driving behavior of a vehicle with a change of driver. For this, driver-specific driving parameters, which characterize a driving style of a driver, of several vehicle drivers are stored as virtual driver profiles in the vehicle or in a drivers' control center. In addition, various algorithms are stored driver-specifically in the vehicle or in a drivers' control center, which respectively modify a reaction of the vehicle to driving parameters of a driver to the effect that a manner of driving, taking into account the limits of the vehicle, is ensured in traffic.

### BACKGROUND

From the publication DE 10 2005 034 936 A1 a method is known for regulating steering in a steering system. For this, in this method aspects of a driving style of a vehicle driver are determined by means of parameters and values which influence and/or describe the movement and hence the driving behavior of the vehicle and in order to influence an additional steering angle or an additional steering moment, in accordance with the determined aspects of the driving style, to produce a steering feel for the driver which is accommodated adaptively.

In this method, the steering regulation in a steering system of a vehicle has superimposed on it additively an additional steering moment or an additional steering angle in accordance with the individual driving style of a vehicle driver, with the driving style of the vehicle driver being determined as a function of at least one value, suited to the description of the movement of the motor vehicle. By the use of a value or a parameter which influences or describes the driving movement, the known method makes possible a simple and informative basis for the assessment of various aspects of the driving style. Parameters which have a direct or indirect influence on the movement of the vehicle make possible a view of the movement of the vehicle which is decoupled from the driving dynamics characteristics of the vehicle.

Racy drivers differ here as a type of driver from drivers who place particular value on driving comfort, for example by the accelerating forces affecting them, which they bring about or still allow on the basis of their driving style. Therefore, physical values such as the longitudinal and the transverse speed of the vehicle and the derivations thereof, namely the longitudinal and the transverse acceleration are used, in order to obtain values which are suited for describing accelerating forces affecting the driver, and accordingly make possible an assessment of the vehicle behavior and the driving style of the driver.

In particular, the information concerning the transverse acceleration can be used, because it is particularly suited to characterize the steering technique of the driver. In addition, information concerning a longitudinal acceleration can be used, which is suited to characterize the behavior with regard to braking and accelerating processes. As a source of such information, corresponding signals from acceleration or wheel speed sensors can be used. The driving styles which are recognized can be stored in a personalized manner according to the prior art and can be retrievable.

In addition, the retrieval of a stored driving style can be linked with an automatic driver recognition and can be configured so as to be selectable by means of a suitable man-machine interface. Driving styles which have already been specified in advance by the manufacturer or driving styles which are to be selected during travel can be provided. The changeover between the driving styles can take place here on the fly or slowly.

This method has the disadvantage that the driving behavior of a vehicle is adapted to the driving style of the driver in order for example to influence and support the steering feel of the driver for example by additional steering angle or additional steering moments, so that a racy driver can still drive more racily and an unhurried driver experiences a more comfortable steering feel, as soon as a driver recognition has identified the driving style of the respective driver.

However, this method for steering regulation in a steering system does not serve for increased driving safety. Rather, it is essential here to slow down the racy driver in good time in dangerous lane-changing and overtaking maneuvers and in the case of speed limits, overtaking prohibitions inter alia, which are detected by the vehicle equipment, such as cameras, sensors, lidar and radar equipment, and to safeguard the driver with an unhurried driving style in precarious situations by possibly extreme acceleration or sudden intensive transverse accelerations during an evasion maneuver before an accident.

From the publication DE 42 11 556 A1 a method is known for this for the driver-adaptive, situation-specific modeling of the car driver's behavior in a real driving environment. By this method, the difficulty of the modeling of the driving behavior and the situation-specific behavior pattern of the individual driver is to be represented with sufficient accuracy. In this known method, the modeling of the driving behavior of a driver is made possible by means of neuronal networks. By means of these neuronal networks, the most varied of information sources are to be linked with each other, and the individual behavior features are to be modeled thereby to the greatest extent in a situation-specific manner, without all classes of situation having to be recognized explicitly.

For this, the neuronal networks are to be trained in order to considerably reduce the creation expenditure for a neuronal driver model. This neuronal driver model can, in turn, be used in a driver support system, in order for example to detect the decrease in driver performance e.g. through tiredness and to warn the driver accordingly. In addition, a driver identification is also possible by means of this known system.

A disadvantage of this known method for the driver-adaptive, situation-specific modeling of the car driver behavior in a real driving environment consists in that by this method only the driver himself is to be identified on the one hand, and on the other hand his driving dynamics behavior is to be assessed in order to recognize e.g. symptoms of fatigue, influences on awareness, intake of alcohol or drug misuse through his situation-specific behavior during driving, and to warn the driver of dangers accordingly. In addition, it is known from this publication that by observing the relative frequency of the deviations of the actual time reserve from a fixed limit, or by comparison with a neuronal network trained to the actual driving behavior, it is to be established whether the driver behavior deviates compared with the normal driver behavior so that, if such deviations are established for a lengthy period of time, warnings can be given for the driver in acoustic, optical or haptic form.

It is at least one object of the application to further develop and improve the methods known in the prior art to the effect that not only are drowsiness and impairment to fitness to drive to be determined or the raciness and the unhurried nature of the driver to be supported, but rather an adaption of the driving behavior of the vehicle to the driver is to be achieved, by safety-relevant algorithms on the controlling of the vehicle with regard to braking, accelerating, changing lane, steering possibilities being modified specifically to the effect that a driving manner of the driving behavior of the vehicle in traffic is ensured, taking into account the limits of the vehicle. In addition, other objects, desirable features and characteristics will become apparent from the subsequent detailed description, and the appended claims, taken in conjunction with the accompanying drawings and this background.

### SUMMARY

A method is created for the adaption of a driving behavior of a vehicle with a change of driver. For this, driver-specific driving parameters, which characterize a driving style of a driver, of several vehicle drivers are stored as virtual driver profiles in the vehicle or in a drivers' control center. In addition, various algorithms are stored driver-specifically in the vehicle or in a drivers' control center, which partly modify a reaction of the vehicle to driving parameters of a driver to the effect that a manner of driving taking into account the limits of the vehicle is ensured in traffic. During the driving of the vehicle, a first of the algorithms is then used and a comparison is carried out of stored virtual driver profiles with actually detected driver-specific driving parameters. If on comparing the actually detected driver-specific driving parameters a change of driver is clearly recognized and an allocation to one of the stored virtual driver profiles was not able to take place, a changeover is made to a next one of the algorithms until the driver is recognized or, if a recognition is not possible by means of the stored data, a further safety algorithm is created and stored for a new virtual driver.

Connected with this method is the advantage that all the information available from the traffic for the driving parameters and data concerning the driving behavior of the vehicle is included in the algorithm, so as not only to improve, check or support the mental state of the driver as in the prior art, but rather to store for the vehicle, on the basis of the varied traffic information, road sign information and movement information of the vehicle in traffic and information data from a car-to-car communication and other sources, a safety algorithm driver-specifically, taking into account these sources of information, in order to select the suitable safety method for the vehicle after detecting the vehicle driver and his driving style.

The safety method makes possible an adaption of the driving behavior of the vehicle to the traffic, carried out taking into account the driving-specific characteristics of the driver. The safety method can intervene greatly here into the controlling of the vehicle, in order to both maintain limits of the vehicle itself and to prevent situations exceeding the limit for the vehicle in traffic, in particular in the case of operating errors by the driver himself.

Therefore, with this method it is entirely possible that a leisurely driver who applies an overtaking maneuver and starts to change lanes, with a massive transverse acceleration of the vehicle is forced back to the original lane by the safety method, because oncoming high-speed traffic, not able to be perceived by the driver, which was detected via the approximation radar belonging to the vehicle, triggered the safety method.

This method also makes it possible for a racy driver to be slowed down by the adaptive behavior of his vehicle unexpectedly at high speed, because behind a crest in the road or a bend in the road, the car-to-car communication has relayed information about traffic congestion, which is taken into consideration in the safety method and the driving behavior of the vehicle reduces the driving speed of the vehicle adaptively by initiating a braking acceleration.

In addition to these information sources, which are incorporated into the safety method, information from braking, and steering or engine equipment of the motor vehicle can also be used, with this information being able to originate from the vehicle itself or from a control unit for controlling the vehicle. However, these parameters may also originate from a control system combination, for example an ESP system or coordinate/control of individual control units.

It is also possible to carry out the characterizing of the driving style of the driver by means of a statistical evaluation and assessment unit, which concerns parameters influencing the movement of the motor vehicle or can be carried out by means of the values describing the movement of the motor vehicle. Here, a designation for example of an additional moment or of an additional steering angle can be made by means of a notification and/or weighting of results from the statistical evaluation or assessment. In this connection, the statistical evaluation of driver-specific steering patterns is provided in relation to steering angle speed, steering angle frequency or number of steering angle changes.

After recognizing a change of driver, the method associated with the driver comes into use for an adaptive driving behavior of the vehicle, in order to give consideration both to the driver and also to the traffic. It is of crucial importance here that by means of this method, a learning effect or training effect is also possible, by which further virtual driver profiles can be created and stored and further adapted safety methods can be formed.

### BRIEF DESCRIPTION OF THE DRAWINGS

The present invention will hereinafter be described in conjunction with the following drawing FIGURE showing a flow diagram in accordance with an embodiment.

### DETAILED DESCRIPTION

The following detailed description is merely exemplary in nature and is not intended to limit the application and uses. Furthermore, there is no intention to be bound by any theory presented in the preceding background or summary or the following detailed description.

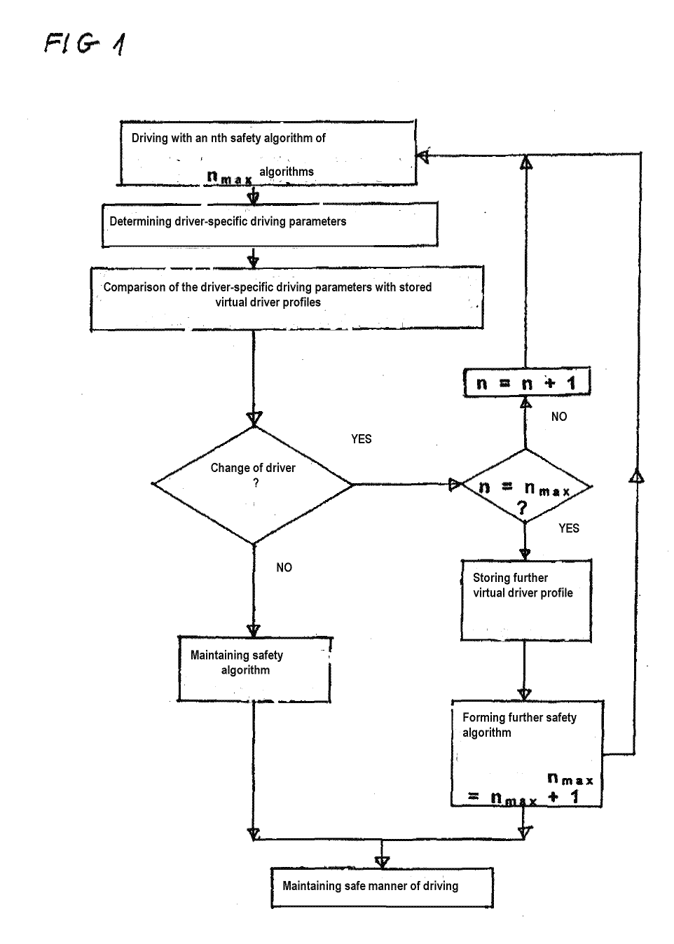

The method will now be explained in further detail by means of a flow diagram which is shown in FIG. 1. Here, a vehicle is used which is already operated by an nth or 1st safety method of nmax methods. During driving, driver-specific driving parameters are determined. From a comparison of the driver-specific driving parameters with stored virtual driver profiles, a check is now made as to whether there has been a change of driver or whether driving can continue with an adjusted safety method of the previous driver.

If it is clearly established that there has been no change of driver, the safety method is maintained and thereby a safe manner of driving in traffic is achieved by the vehicle. If, however, a change of driver is established, a check must be carried out as to whether the maximum method was already reached with the nth safety method. This means that all the driver profiles are checked through with the associated methods. If this is not the case, then a changeover is made to the next safety method and a comparison is carried out again with determined driver-specific driving parameters.

If, however, all nmax methods have been checked and none of these safety methods matches the determined driver-specific driving parameters, a further virtual driver profile is created and stored and also a further safety method is formed and the maximum number of methods is increased by 1. With this improved method, a safe manner of driving can be maintained, when the driver who matches the further virtual driver profile operates the vehicle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for adaption of a driving behavior of a vehicle, comprising:
storing of driver-specific driving parameters that characterize a driving style of a driver of several vehicle drivers in virtual driver profiles;
storing of methods that respectively modify a reaction of the vehicle to driver-specific driving parameters to effect a manner of driving taking into account limits of the vehicle is ensured in traffic;
using a first of the methods during the driving of the vehicle;
comparing stored virtual driver profiles with actually detected driver-specific driving parameters; and
making a changeover to a next one of the methods if on comparing the actually detected driver-specific driving parameters and a change of driver was clearly recognized and an allocation to one of the virtual driver profiles is open.

2. The method according to claim 1, further comprising creating a further method that makes provision of a manner of driving taking account of the limits of the vehicle is ensured in traffic for a new driver-specific driving parameters if on comparing the actually detected driver-specific driving parameters and the change of driver was recognized and the allocation is not possible to one of the virtual driver profiles.

3. The method according to claim 1, further comprising maintaining the method is maintained if on comparing the actually detected driver-specific driving parameters clearly the change of driver was not recognized.
